(19) United States
(12) Patent Application Publication
(10) Pub. No.: US 2008/0187628 A1
(43) Pub. Date: Aug. 7, 2008

(54) Water-Soluble, Quick-Dissolve Flavor Tablets

(76) Inventors: Melinda L. Champion, Haddonfield, NJ (US); Joshua R. Slavitt, Merion, PA (US)

Correspondence Address: SYNNESTVEDT & LECHNER, LLP, 1101 MARKET STREET, SUITE 2600, PHILADELPHIA, PA, 19107-2950, US

(21) Appl. No.: 11/670,788

(22) Filed: Feb. 2, 2007

(51) Int. Cl. A23L 1/22; A23L 1/27; A23L 1/302; A23L 1/48; A23L 2/38

(52) U.S. Cl. 426/61; 426/250; 426/590; 426/650; 426/71; 426/72

(57) ABSTRACT

The invention is directed to quick-dissolve flavor tablets for use by consumers in flavoring beverages, such as water, and methods for flavoring such beverages. The tablet comprises a flavor component and a quick-dissolve carrier component which disintegrates rapidly upon placement into the beverage container with minimal residue.

### FIELD

This invention pertains to the field of water enhancement. More specifically, the invention pertains to flavored, water-soluble, quick-dissolve tablets and methods to flavor water using such tablets in order to provide flavor satisfaction. The flavored tablets may optionally contain one or more functional, nutritional and/or nutraceutical fortifications, or medicaments as well.

### BACKGROUND

Consumption of water and other fluids is necessary for human life. Most people do not consume the recommended six to eight cups of water per day.

The lack of portability of water has limited consumption, as carrying a glass of water when “on the go” is not a practical solution. The convenience and portability of water consumption has been addressed through the manufacturing and wide distribution of bottled water, which allow consumers to take convenient amounts of water with them when away from home.

Another factor limiting the consumption of the recommended six to eight cups of water per day is the perception that plain water, whether bottled or otherwise, is boring.

To make water more appealing to drink, consumers can add natural flavors to water, such as a slice of lemon or lime. Fruit, however does not meet consumers' need for convenience and portability. Fresh fruits such as lemon, lime or orange slices are not practical to carry on one's person, and so are not useful when away from home. Also, it is difficult and messy to attempt to wedge a piece of fruit into a bottle of water.

To make water more appealing to drink, consumers can add other additives, such as liquid or powdered flavoring. These currently existing manufactured additives to water do not meet consumers' need for convenience and flexibility of dispensing and use. Liquid and powdered flavorings tend to be messy and/or awkward to dispense and to use.

Pre-measured flavorings also do not give the consumer any control over the strength of flavor of a given quantity of water. This “one size fits all” approach does not meet the needs of many consumers who would like a stronger- or a weaker-flavored water.

Pre-flavored bottled waters exists, however they do not meet the requirements of many consumers. Pre-flavored waters do not give consumers control over the strength of flavor in the water; consumers must take what is offered. Consumers have no opportunity to make the flavor weaker or stronger to their liking.

Pre-flavored water is available in a number of flavors, for example lime, lemon, and raspberry. Given that the water is pre-flavored, however, this gives the consumer no opportunity to mix-and-match flavors to their liking. If a consumer wants a lime-raspberry combination, or a lemon-lime-raspberry combination, and that combination is not available in a given brand's flavor line-up, then the pre-flavored waters give consumers no ability to experience their desired flavor blends.

Pre-flavored waters are also significantly more expensive than plain water, which does not meet the cost requirements of many consumers, discouraging many people from purchasing and consuming pre-flavored waters, which may in turn discourage consumers from drinking the recommended six to eight cups of water per day.

Easy-to-ingest fortification is of interest to many. The most common form of vitamins, minerals, herbs and other fortifications is solid oral dosage pills or tablets, which many people are unwilling or unable to swallow. An easy-to-dispense, easy-to-use, and easy-to-consume, non-pill dosage form for fortification is a consumer need that is not currently being met by existing products.

Quick-dissolve tablets have been confined in the prior art to dispensing medicaments via a rapidly dissolving solid oral dosage form, i.e. consuming the tablets by placing them directly on the tongue and allowing them to dissolve.

Cima Labs markets OraSolv®, which is an effervescent direct compression tablet having an oral dissolution time of five to thirty seconds, and DuraSolv®, which is a direct compression tablet having a taste-masked active agent and an oral dissolution time of 15 to 45 seconds. WO 98/46215 for “Rapidly Dissolving Robust Dosage Form,” assigned to Cima Labs, is directed to a hard, compressed, fast melt formulation having an active ingredient and a matrix of at least a non-direct compression filler and lubricant. A non-direct compression filler is typically not free-flowing, in contrast to a direct compression filler, and usually requires additionally processing to form free-flowing granules. Cima also has U.S. patents and international patent applications directed to effervescent dosage forms (U.S. Pat. Nos. 5,503,846, 5,223,264, and 5,178,878) and tableting aids for rapidly dissolving dosage forms (U.S. Pat. Nos. 5,401,513 and 5,219,574), and rapidly dissolving dosage forms for water soluble drugs (WO 98/14179 for “Taste-Masked Microcapsule Composition and Methods of Manufacture”). The disclosures of the foregoing publications are incorporated herein by reference.

Fuisz Technologies, now part of BioVail, markets Flash Dose®, which is a direct compression tablet containing a processed excipient called Shearform®. Shearform® is a cotton candy-like substance of mixed polysaccharides converted to amorphous fibers. U.S. patents describing this technology include U.S. Pat. No. 5,871,781 for “Apparatus for Making Rapidly Dissolving Dosage Units;” U.S. Pat. No. 5,869,098 for “Fast-Dissolving Comestible Units Formed Under High-Speed/High-Pressure Conditions;” U.S. Pat. Nos. 5,866,163, 5,851,553, and 5,622,719, all for “Process and Apparatus for Making Rapidly Dissolving Dosage Units and Product Therefrom;” U.S. Pat. No. 5,567,439 for “delivery of Controlled-Release Systems;” and U.S. Pat. No. 5,587,172 for “Process for Forming Quickly Dispersing Comestible Unit and Product Therefrom,” the disclosures of which are incorporated herein by reference.

Prographarm markets Flashtab®, which is a fast melt tablet having a disintegrating agent such as carboxymethyl cellulose, a swelling agent such as a modified starch, and a taste-masked active agent. The tablets have an oral disintegration time of under one minute (U.S. Pat. No. 5,464,632), the disclosure of which is incorporated herein by reference.

Yamanouchi-Shaklee markets Wowtab®, which is a tablet having a combination of a low-moldability and a high-moldability saccharide. U.S. Patents covering this technology include U.S. Pat. No. 5,576,014 for “Intrabuccally Dissolving Compressed Moldings and Production Process Thereon” and U.S. Pat. No. 5,446,464 for “Intrabuccally Disintegrating Preparation and Production Thereof,” the disclosures of which are incorporated herein by reference.

Other companies with rapid-dissolve technology include Janssen Pharmaceutica. U.S. patents assigned to Janssen describe rapidly dissolving tablets having two polypeptide (or gelatin) components and a bulking agent, wherein the two components have a net charge of the same sign, and the first component is more soluble in aqueous solution than the second component. See U.S. Pat. No. 5,807,576 for “Rapidly Dissolving Tablet;” U.S. Pat. No. 5,635,210 for “Method of Making a Rapidly Dissolving Tablet;” U.S. Pat. No. 5,595,761 for “Particulate Support Matrix for Making a Rapidly Dissolving Tablet;” U.S. Pat. No. 5,587,180 for “Process for Making a Particulate Support Matrix for Making a Rapidly Dissolving Tablet;” and U.S. Pat. No. 5,776,491 for “Rapidly Dissolving Dosage Form,” the disclosures of which are incorporated herein by reference.

Eurand America, Inc. has U.S. patents directed to a rapidly dissolving effervescent composition having a mixture of sodium bicarbonate, citric acid, and ethylcellulose (U.S. Pat. Nos. 5,639,475 and 5,709,886), the disclosures of which are incorporated herein by reference.

L.A.B. Pharmaceutical Research owns U.S. patents directed to effervescent-based rapidly dissolving formulations having an effervescent couple of an effervescent acid and an effervescent base (U.S. Pat. Nos. 5,807,578 and 5,807,577), the disclosures of which are incorporated herein by reference.

Schering Corporation has technology relating to buccal tablets having an active agent, an excipient (which can be a surfactant) or at least one of sucrose, lactose, or sorbitol and either magnesium stearate or sodium dodecyl sulfate (U.S. Pat. Nos. 5,112,616 and 5,073,374), the disclosures of which are incorporated herein by reference.

For many people, however, the sensation of a medicament dissolving on the tongue is not pleasant. Many people also are unwilling or unable to swallow pills. A need for an alternate delivery system for medicaments exists.

### SUMMARY OF THE INVENTION

Various embodiments of water-soluble, quick-dissolve flavor tablets that disintegrate quickly upon placement in a beverage are disclosed.

One aspect of the present invention describes a method for flavoring water through the use of a quickly-dissolving tablet to be dissolved in a liquid, such as a bottle of water, where it will quickly disintegrate, leaving little residue, and will flavor the water, making consumption of the water more appealing by providing flavor satisfaction.

The tablets may be sweetened, using a natural or an artificial sweetener or sweeteners, or a combination thereof.

The tablets may be colored, using natural or artificial coloring.

The tablets are sized to fit easily into the mouth of a bottle of water, making them easy, convenient, and neat to use.

A plurality of tablets may be packaged in a portable, easy-to-carry and easy-to-use dispenser. Unlike current options for flavoring water, the tablets are neatly dispensed in any quantity, providing simplicity, precision, and flexibility of use.

Solid, quick-dissolve tablets allows for flavor intensity control, as any number of tablets could be dispensed and added to a given quantity of water to produce the desired strength of flavor.

Additional flavor manipulation by the consumer is also possible, as multiple tablets of different flavors may be added to a given quantity of water to produce a “custom blended” flavor, as the consumer desires.

The tablets may be of any shape, and may contain embossing and/or printing in or on the exterior of the tablet to provide educational, advertising, or entertainment value to the consumer.

In another embodiment, a flavored quick-dissolve tablet is provided which includes effervescing properties, which can aid in dissolution of the tablet, and/or provide enjoyment value to the consumer.

In another embodiment, a flavored quick-dissolve tablet that incorporates single or multiple vitamins and/or minerals and/or herbs and/or plant extractives and/or stimulants and/or probiotics or prebiotics, or other nutritional, functional, or nutraceutical fortifications in any combination meets a need for easily consumed fortification, as the tablet will dissolve readily in any liquid, bottled or otherwise.

In another embodiment, a flavored quick-dissolve tablet to be dissolved in an appropriate quantity of water or other beverage, and that includes one or more medicaments and may be sweetened or unsweetened, will provide an easy method for consumers to ingest a medication. The easy dispensing and consumption of various medications, both prescription and non-prescription, can be accomplished with a quick dissolve flavor tablet dissolved in water or another beverage and then consumed. These medicaments in a quick-dissolve flavor tablet could be available for direct purchase by the consumer (“over-the-counter”), or through a medical prescription.

### BRIEF DESCRIPTION OF THE DRAWINGS

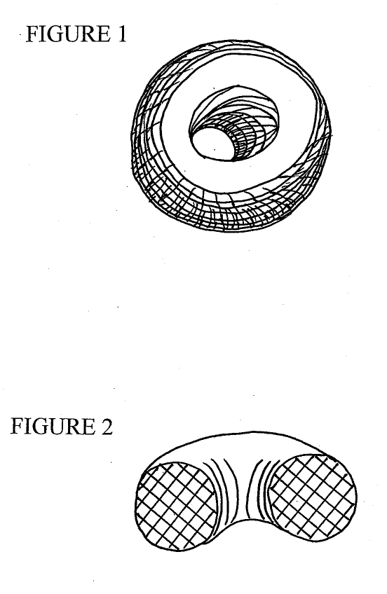

In FIG. 1, a tablet is depicted having a toroidal shape.

In FIG. 2, a cross-sectional view of a toroidal-shaped tablet is provided.

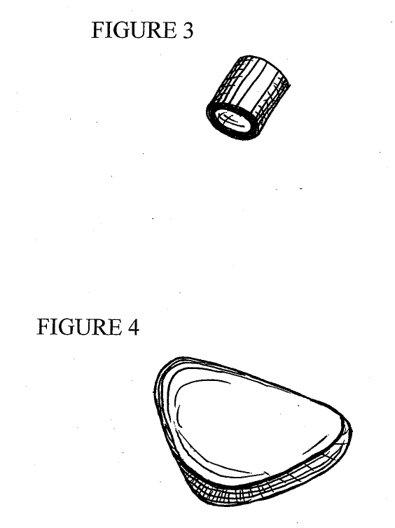

In FIG. 3, a tablet is depicted having a tubular shape.

In FIG. 4, a tablet is depicted having a triangular shape.

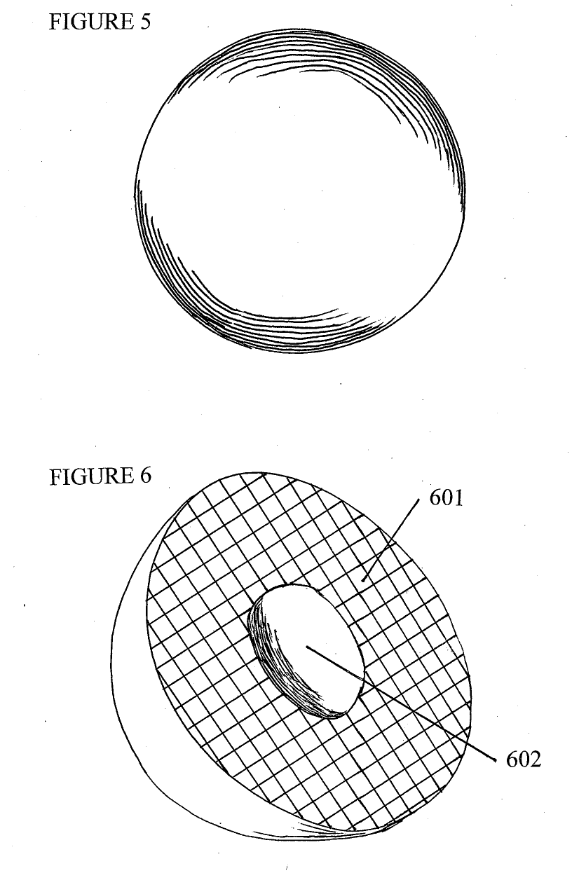

In FIG. 5, a tablet is depicted having a spherical shape.

In FIG. 6, a cross-section view of a spherically-shaped tablet is shown as a solid tablet with a hollow containment chamber into which one or more solid, liquid, powdered, and/or granulated ingredients may be enclosed.

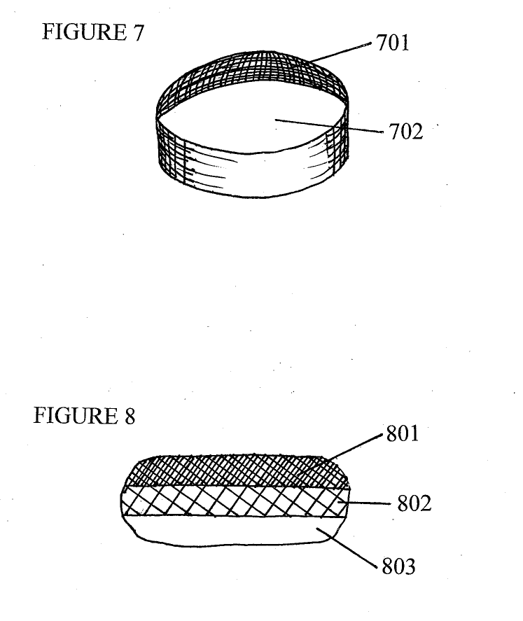

In FIG. 7, a two-layer tablet having a rounded disc shape is shown having layers that may be of the same or of different materials.

In FIG. 8, a three-layer tablet having an elliptical shape is shown having layers that may be of the same or of different materials.

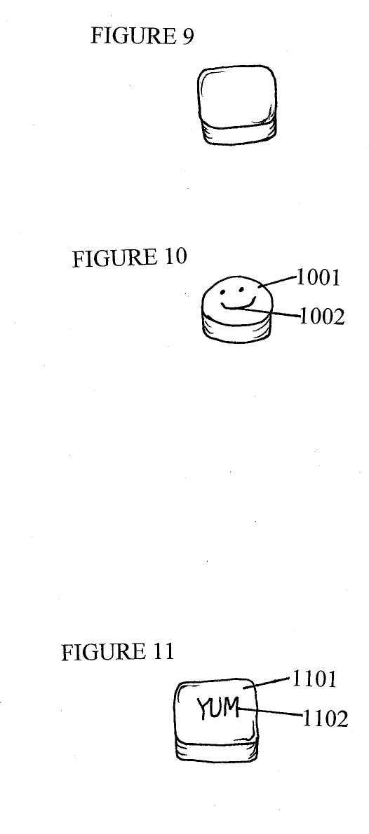

In FIG. 9, a tablet is depicted having a square shape.

In FIG. 10, a tablet is depicted that includes a tablet bearing a graphic image.

In FIG. 11, a view of a tablet is provided that shows a tablet bearing lettering.

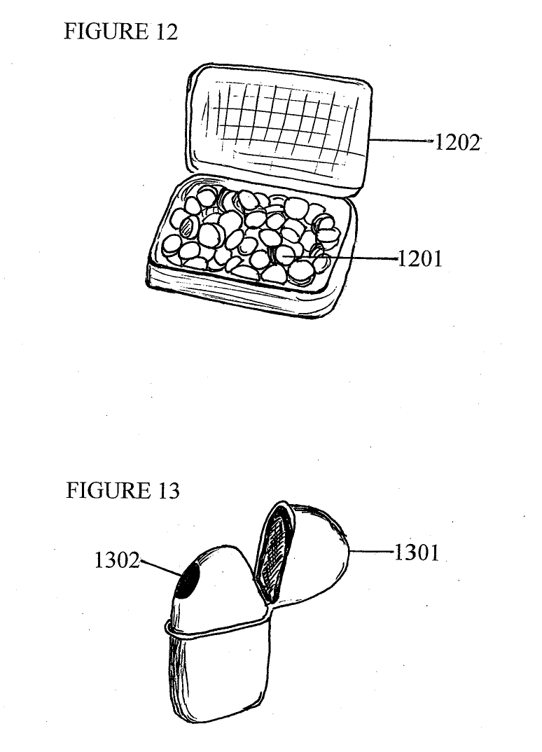

In FIG. 12, a container is depicted having loose tablets contained therein having a snap-open and snap-close lid.

In FIG. 13, a container is depicted having loose tablets contained therein (tablets not visible) and dispensed singularly or multiply by opening the top of the container and shaking out the desired number of tablets via the opening in the container.

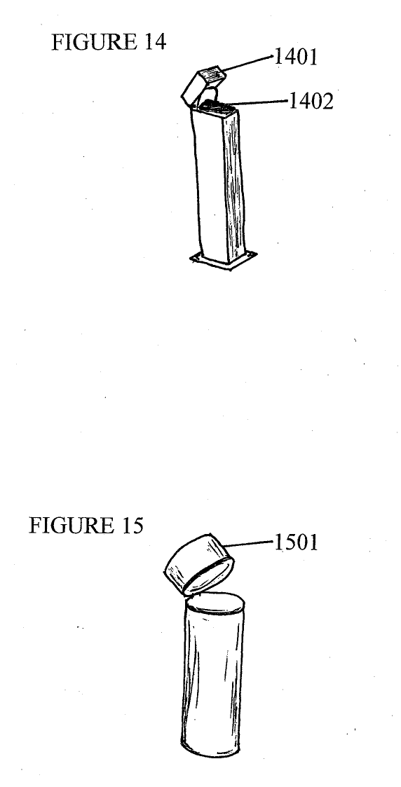

In FIG. 14, a container is depicted having tablets stacked therein, and a spring-loaded dispenser, (not shown), such that when the lid is drawn back a tablet is dispensed.

In FIG. 15, a container is depicted having tablets stacked therein (tablets not visible) with a flip-top lid.

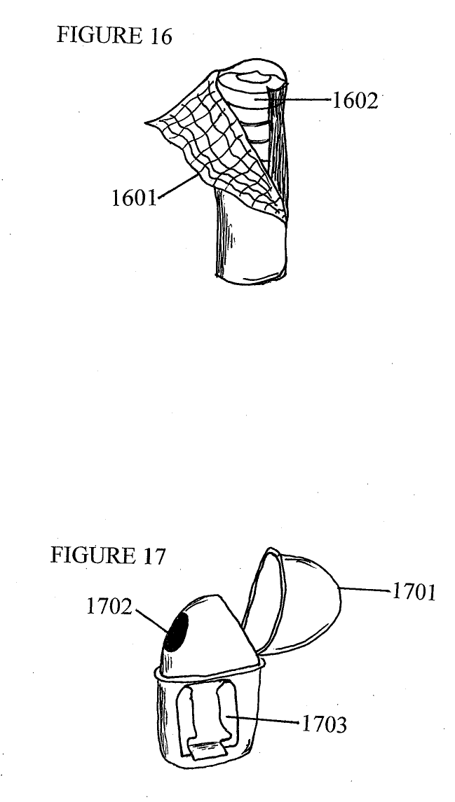

In FIG. 16, a package is depicted having a wrapped roll of tablets therein in which the wrapping can be torn open for easy access to tablets.

In FIG. 17, a package is depicted showing a tablet dispenser containing loose tablets (tablets not visible), a flip top with an opening from which tablets can be shaken out, and an integrated belt clip.

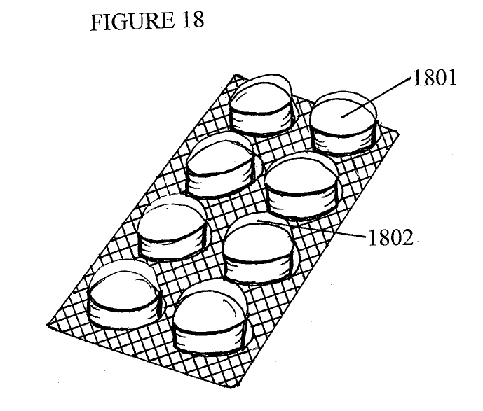

In FIG. 18, a package is depicted showing a blister pack containing tablets enclosed within individual chambers, the reverse side of which (not shown) being sealed with a foil backing or similar material, such that individual tablets may be pushed out through the foil backing by the consumer.

### DETAILED DESCRIPTION OF PREFERRED EMBODIMENTS

According to one aspect of the invention, there is provided a quick-dissolve flavor tablet for flavoring a beverage in a container. The tablet comprises a flavor component and a quick-dissolve carrier component which disintegrates rapidly upon placement into the beverage container with minimal residue.

The flavor component includes at least one flavoring which may be a natural or artificial flavor, or combinations thereof. The flavoring is capable of providing a flavor sensation to a consumer of a beverage into which the tablet has been dissolved.

The tablet is readily water-soluble such that it disintegrates quickly upon placement in a beverage, with minimal residue, within a time period selected from the group consisting of less than about 1 minute, less than about 45 seconds, less than about 30 seconds, less than about 15 seconds, less than about 10 seconds, less than about 5 seconds, less than about 3 seconds, and less than about 1 second.

A sweetener or sweeteners, either natural, artificial, or combinations thereof, providing a sweet sensation, may also be used.

The tablet may be singly or multiply colored, using natural or artificial colors, or may not contain any added coloring at all. Similarly, the tablet my provide coloring to the water into which it is placed, or may not affect the color of the water at all.

The tablet may be made from a base formula containing free flowing granules, a slurry, or a paste. Water may be present in the formula and then partially or completely dried out of the tablet either before or after forming.

The tablet may have visual representations printed or embossed in or on the tablet.

Additional layers or materials may be provided to preserve the structure of the tablet prior to use.

In one embodiment, the tablet may feature a hollow chamber inside the tablet to contain other ingredients in addition to the base tablet formulation.

In another embodiment, the tablet may effervesce for the enjoyment of the consumer and/or to aid dissolution of the tablet when placed into an aqueous medium.

The tablet may be manufactured in a number of ways. Common manufacturing techniques could include extrusion, or via a direct compression filler, or via a non-direct compression filler. The preferred manufacturing technique will involve lower compression forming to ensure optimal friability.

A plurality of tablets may be packaged into a portable, easy to use dispenser, which facilitates the convenience and ease of use of the tablets.

According to another aspect of the invention, there is provided a sweetened or unsweetened, quick-dissolve, water-soluble, flavored tablet providing fortification, including single or multiple vitamins and/or minerals and/or herbs and/or plant extractives and/or stimulants and/or prebiotic or probiotics, or other nutritional, functional, or nutraceutical enhancements in any combination, are described in general and by way of specific examples below.

According to another aspect of the invention, there is provided a sweetened or unsweetened, water-soluble quick-dissolve flavor tablet which contains one or more medicaments. The tablet which includes one or more medicaments may be available to consumers to purchase directly (“over the counter”), or with a medical prescription.

According to another aspect of the invention, there is provided a method for flavoring water comprising the steps of (a) dispensing one or more tablets of the present invention, (b) placing said one or more tablets into a container of water, and (c) agitating the container to substantially dissolve the one or more tablets.

According to another aspect of the invention, there is provided a method for customizing the flavor strength of water by using multiple tablets in a given volume of water to create a more strongly flavored water in accordance with the consumer's taste.

According to another aspect of the invention, there is provided a method for customizing the flavor of water by adding differently-flavored tablets to a volume of water. By way of example, into a 500 mL bottle of water could be placed two raspberry flavored tablets and one lime flavored tablet to create raspberry-flavored water with a hint of lime.

Tablet Ingredients

The quick-dissolve tablet comprises a flavor component and a quick-dissolve carrier component capable of dissolving quickly upon placement in a beverage. The tablet may also include a variety of ingredients compatible with its quick-dissolving properties. The tablet may include, for example, water (which can be later partially or completely be removed from the tablet), sweeteners, acids, gelatin components, bulking agents, and carbohydrates. Other additives may also be used for purposes such as forming, plasticizing, stabilizing, emulsifying, bulking, thickening, binding, coloring, lubricating, effervescing, or acting as a surfactant. By way of example, one exemplary embodiment of the quick-dissolve tablet may have ingredients as shown in Table 1.

TABLE 1

| Ingredient | Weight Percent |
|---|---|
| Flavor | 0.001–80% |
| Cane sugar | 0–80% |
| Malic acid | 0–25% |
| Polyvinylpyrrolidone | 1–10% |
| Potassium citrate | 0–5% |
| L-leucine | 0–5% |
| Polyethylene glycol | 0–5% |
| Sucralose | 0–5% |
| Silica | 0–5% |

Flavor Component

The flavor component provides the flavor satisfaction for beverage consumers. The flavor component may comprise one or more natural or artificial flavors, or combinations thereof.

The tablet will provide desired flavors, such as by example but not limitation, lemon or lime, for water or other beverages, without the consumer ingesting significant amounts of those substances. By providing such flavors, and thereby flavor satisfaction, the tablet can encourage increased water consumption.

One aspect of the tablet is the use of more than one flavor in a single tablet. Such a multiplicity of flavor combinations enhances the drinking experience.

The tablet may be layered with different flavors with each layer bearing a color associated with its flavor. Alternatively, multiple flavors may be included in a tablet with no color differentiation apparent on the tablet.

Suitable flavorings include those known to the skilled artisan, such as natural and artificial flavors. These flavorings may be chosen from synthetic flavor oils and flavoring aromatics, and/or oils, oleo resins and extracts derived from plants, leaves, flowers, fruits, vegetables, and so forth, and combinations thereof. Representative flavor oils include: spearmint oil, cinnamon oil, peppermint oil, clove oil, bay oil, thyme oil, cedar leaf oil, oil of nutmeg, oil of sage, and oil of bitter almonds. Also useful are artificial, natural or synthetic fruit flavors such as vanilla, chocolate, coffee, cocoa and citrus oil, including lemon, orange, grape, lime and grapefruit and fruit essences including apple, pear, peach, strawberry, raspberry, cherry, plum, pineapple, apricot, rose hips, and so forth, and vegetable flavors such as tomato, cucumber, wheat grass, capsacinoids, and so forth. These flavorings can be used individually or in combination. Commonly used flavors include mints such as peppermint, wintergreen, spearmint, birch, anise and such fruit flavors, as cherry, lemon, lime, orange, grape, artificial vanilla, and such spice and herb flavors such as cinnamon derivatives, ginger, lemongrass, basil, lavender, whether employed individually or in a mixture.

Flavorings such as aldehydes and esters including cinnamyl acetate, cinnamaldehyde, citral, diethylacetal, dihydrocarvyl acetate, eugenyl formate, p-methylanisole, and so forth may also be used. Generally, any flavoring or food additive, such as those described in Chemicals Used in Food Processing, publication 1274 by the National Academy of Sciences, pages 63-258, which is incorporated herein by reference, may be used. Further examples of aldehyde flavorings include, but are not limited to acetaldehyde (apple); benzaldehyde (cherry, almond); cinnamic aldehyde (cinnamon); citral, i.e., alpha citral (lemon, lime); neral, i.e. beta citral (lemon, lime); decanal (orange, lemon); ethyl vanillin (vanilla, cream); heliotropine, i.e., piperonal (vanilla, cream); vanillin (vanilla, cream); alpha-amyl cinnamaldehyde (spicy fruity flavors); butyraldehyde; citronellal (modifies, many types); decanal (citrus fruits); aldehyde C-8 (citrus fruits); aldehyde C-9 (citrus fruits); aldehyde C-12 (citrus fruits); 2-ethyl butyraldehyde (berry fruits); hexenal, i.e. trans-2 (berry fruits); tolyl aldehyde (cherry, almond); veratraldehyde (vanilla); 2,6-dimethyl-5-heptenal, i.e. melonal (melon); 2-6-dimethyloctanal (green fruit); and 2-dodecenal (citrus, mandarin); cherry; grape; mixtures thereof; and the like.

The amount of flavoring employed is normally a matter of preference subject to such factors as flavor type, individual flavor, and strength desired. Thus, the amount may be varied in order to obtain the result desired in the final product. Such variations are within the capabilities of those skilled in the art without the need for undue experimentation. In general, amounts of about 0.001 to about 80 weight % are usable.

Sweeteners

Flavored tablets sweetened with artificial sweetener will encourage water consumption without increasing the calories ingested. Artificial sweeteners, while contributing no or a minimal number of calories, can impart an aftertaste to a beverage flavored and sweetened by inclusion of a quick-dissolve flavor tablet. Additionally, different sweeteners impart their peak sweetness at different times and rates over the time that a beverage into which a flavor tablet has been dissolved stays in a consumer's mouth. The artificial sweeteners may be used in combination to level the sweetness sensation over time, and to minimize any potential aftertaste.

Use of natural sweeteners in combination with one or more artificial sweeteners can also be used to mitigate the aftertaste and peak sweetness issues. Natural or artificial sweeteners may also be used singly, rather than in combination.

Suitable sweeteners that can be included are those well known in the art, including both natural and artificial sweeteners. Suitable sweeteners include, by example:

A. Water-soluble sweetening agents such as monosaccharides, disaccharides and polysaccharides such as xylose, ribose, glucose (dextrose), mannose, galactose, fructose (levulose), sucrose (sugar), honey, maltose, invert sugar (a mixture of fructose and glucose derived from sucrose), partially hydrolyzed starch, corn syrup solids, dihydrochalcones, monellin, steviosides, and glycyrrhizin;

B. Water-soluble artificial sweeteners such as the soluble saccharin salts, i.e., sodium or calcium saccharin salts, cyclamate salts, the sodium, ammonium or calcium salt of 3,4-dihydro-6-methyl-1,2,3 - - - oxathiazine-4-one-2,2-dioxide, the potassium salt of 3,4-dihydro-6-methyl-1,2,3-oxathiazine-4-one-2,2-dioxide (acesulfame-K), the free acid form of saccharin, and the like;

C. Dipeptide based sweeteners, such as L-aspartic acid derived sweeteners, such as L-aspartyl-L-phenylalanine methyl ester (aspartame) and materials described in U.S. Pat. No. 3,492,131, L-alpha-aspartyl-N-(2,2,4,4-tetramethyl-3-thietanyl)-D-alaninamide hydrate, methyl esters of L-aspartyl-L-phenylglycerin and L-aspartyl-L-2,5-dihydrophenylglycine, L-aspartyl-2,5-dihydro-L-phenylal-anine, L-aspartyl-L-(1-cyclohexyen)-alanine, and the like;

D. Water-soluble sweeteners derived from naturally occurring water-soluble sweeteners, such as a chlorinated derivative of ordinary sugar (sucrose), known, for example, under the product description of sucralose; and

E. Protein based sweeteners such as thaumatoccous danielli (Thaumatin I and II).

Other sweeteners may be used as well.

In general, amounts of about 0.01 to about 80 weight % are usable, depending upon the type of sweetener used.

Quick-Dissolving Carrier Component

The quick-dissolving carrier component provides the rapid disintegration of the tablet with minimal residue upon placement in a beverage container. The quick-dissolving carrier component may comprise any suitable material capable of providing the quick-dissolving characteristics and include, for example, sugars such as lactose, glucose, or mannose; sugar alcohols such as mannitol, sorbitol, xylitol, erythritol, lactitol, or maltitol; reduced starch saccharide; reduced paratinose; a starch or modified starch, such as corn starch, potato starch, or maize starch; sodium starch glycolate; water-soluble carbohydrates; proteins; oligosaccharides; natural polymers or a synthetic derivatives of a natural polymer such as gelatin, carrageenan, pectin, an alginate, dextrin, dextran, or maltodextran; a natural gum such as acacia or xanthan gum; polymers such as polyvinylpyrrolidone, crospovidone, croscarmellose sodium, polyvinyl alcohol, polyoxyethylene copolymers, polyoxypropylene copolymers, polyethylene glycol, and polyethylene oxide; low-density alkali earth metal salts; and cellulosic materials such as cellulose, microcrystalline cellulose, wood, chemothermal mechanical pulp, cereal covers such as from oats, wheat, corn or rice, and residues and extracts of oranges, lemons, tomatoes, apples, grapes, sugar beets, peas, cabbage, potatoes, cucumbers, coconuts, nuts, and coffee.

Low-density alkali earth metal salts can include calcium carbonate, calcium hydroxide, magnesium carbonate, magnesium hydroxide, aluminum hydroxide, magnesium silicate, magnesium aluminate, or aluminum magnesium hydroxide. Water-soluble carbohydrates are preferably highly porous and can be selected from a high-moldability or low-moldability type. High-moldability type, water-soluble carbohydrates include maltose, maltitol and sorbitol. Low-moldability type, water soluble carbohydrates include mannitol, glucose, sucrose and xylitol.

Additional suitable materials are disclosed in U.S. Pat. Nos. 5,073,374; 5,466,464; 5,576,014; 5,720,974; 5,837,285; 5,869,098 which all disclose different forms of fast-dissolving buccal tablets, and U.S. Pat. No. 5,085,876 which discloses a fast-dissolving sweetening agent in granular or powder form, the disclosures of which are incorporated herein by reference. Suitable materials are also disclosed in U.S. Pat. Publ. Nos. 2003/0175400, 2003/0215502, and 2004/0161459, and in U.S. Pat. Nos. 6,126,979 and 6,162,474, the disclosures of which are incorporated herein by reference. In general, amounts of about 1 to about 80 weight % are usable, depending upon the type of carrier component used.

Other Ingredients

Further ingredients may be added to accomplish the purposes of the tablet. A quick-dissolve, water-soluble tablet that is permeated with single or multiple nutritional fortifications, such as vitamin(s), mineral(s), stimulant(s), herb(s) and other plant-based enhancements, probiotic(s), prebiotic(s), nutraceutical(s), other functional ingredients, or other enhancements in the tablet formulation, and which is flavored and may be sweetened, and when added to beverages which disintegrates rapidly, leaving little or no residue upon placement into an aqueous solution, and which provides flavor satisfaction and fortification to a consumer when dissolved in water.

Vitamins, provitamins and co-enzymes that may be delivered using this invention include, but are not limited to, vitamin A, vitamin C, vitamin D, vitamin E, thiamin, riboflavin, niacin, pantothenic acid, pyridoxine, folic acid, cobalamin, vitamin K, biotin, nicotinic acid, flavin, choline, inositol, paraminobenzoic acid, carnitine, carotenoids including beta carotene, and retinoic acid. Minerals that may be delivered include calcium, chromium, copper, fluoride, iodine, iron, magnesium, manganese, molybdenum, phosphorus, selenium, zinc.

Stimulant enhancements could include, by example, but not by limitation, caffeine and guarana.

Herbal and other plant-based enhancements could include, by example, but not by limitation, bilberry standard extract, black cohosh, cascara sagrada bark, cranberry fruit, echinacea, evening primrose oil, flaxseed oil, garlic, ginger root, ginkgo biloba, ginseng, eleuthero, goldenseal root, grape seed extract, soy and soy extracts, green tea extract, milk thistle, saw palmetto, St. John's wort, and Valerian root extract.

Probiotic, prebiotic and other nutraceutical enhancements could include, by example, but not by limitation, acidophilus, bifidus, inulin, fructooligosaccharides, galactooligosaccharides, soya oligosaccharides, resistant starch, isomaltooligosaccharides, lactosucrose and xylo-oligosaccharides, tagatose, pectin, dextrins, and larch arabinogalactan.

Other enhancements could include, by example, but not by limitation, proteins of various sources, electrolytes, fish oil, DHA, ARA, alpha lipoic acid, conjugated linoleic acid, coenzyme Q10, omega-3, omega-6, lecithin, choline, lysine, amino acid(s), camitine, melatonin, glucosamine, chondroitin, MSM, vinpocetine, isoflavones, phytoestrogens.

In general, amounts of about 0.1 to about 50 weight % are recommended for additional fortifying ingredients, dependant upon the type of fortification in use.

Encapsulation

The tablets can also provide for encapsulation of other materials, such as stimulants, vitamins, minerals, herbs, nutraceuticals, and the like. Encapsulation can take many forms, and the following examples are not by way of limitation.

Encapsulation can be achieved through liquefaction and/or granulation and mixing into the tablet ingredients, or layering, or through a containment chamber within the tablet.

The ingredient desired to be encapsulated can be directly coated onto the tablet using pill coating techniques.

The tablet can be made whole around a solid, liquid, powdered, or granulated center by using the known techniques and equipment.

The tablets also can include a preservative. The preservative may be added in amounts from about 0.001 weight % to about 5 weight %, preferably from about 0.01 weight % to about 1 weight % of the tablet. Useful preservatives include sodium benzoate and potassium sorbate.

Other ingredients in the quick-dissolve tablets to affect binding, thickening, filling, stabilizing and the like can optionally include, but are not limited to, cellulose ethers, modified starches, natural gums, edible polymers, hydrocolloid flours, seaweed extracts, land plant extracts, derivatives thereof, and combinations thereof. These may be found in the tablet in amounts from about 0.001 weight % to about 90 weight %.

Examples of cellulose ethers include, but are not limited to, methylcellulose, ethylcellulose, hydroxymethylcellulose, hydroxyethylcellulose, hydroxypropylmethylcellulose, carboxymethylcellulose, derivatives thereof, and combinations thereof.

Examples of modified starches include, but are not limited to, acid and enzyme hydrolyzed corn and potato starches.

Examples of natural gums include, but are not limited to, gum Arabic, guar gum, locust bean gum, carageenan gum, acacia, karaya, ghatti, tragacanth agar, tamarind gum, xanthan gum, derivatives thereof, and combinations thereof.

Examples of edible polymers include, but are not limited to, microcrystalline cellulose, cellulose ethers, xanthan, derivatives thereof, and combinations thereof.

Examples of hydrocolloid flour include, but are not limited to, guar gum, locust bean, microcrystalline cellulose, tara, derivatives thereof, and combinations thereof.

Examples of seaweed extracts include, but are not limited to, alginates, carageenans, derivatives thereof, and combinations thereof.

Examples of land plant extract examples include, but are not limited to, konjac, pectin, arabinoglactan, derivatives thereof, and combinations thereof.

Binders

Useful binding agents include starch, in amounts ranging from about 0 to about 10 weight % or more, as well as other binders known in the field. Other examples include casein and pullulan.

Thickeners

To further enhance the structure of the tablet compositions, an effective amount of a thickening agent may be used. Suitable thickening agents include, but are not limited to, cellulose ethers, such as microcrystalline cellulose, hydroxyethylcellulose, hydroxypropylmethylcellulose, or hydroxypropylcellulose, either alone or mixtures thereof. Other useful thickening agents include methylcellulose, carboxylmethylcellulose, and the like, in amounts ranging from about 0 to about 20 weight % or otherwise.

Polymers are also useful thickeners, such as carbomer, polyvinylpyrrolidone, carboxymethylcellulose, poly(vinyl alcohol), sodium alginate, polyethylene glycol, natural gums like xanthan gum, tragacanth gum, guar gum, acacia gum, gum Arabic, and water-dispersible polyacrylates like polyacrylic acid, methylmethacrylate copolymer, and carboxyvinyl copolymers. The concentration of a water-soluble polymer in the final tablet can be as desired or can vary from about 0 to about 75 weight %.

Fillers

A bulk filler agent may be added to the tablet for many purposes. The effective amount of the bulk filler can vary, and can in some instances range from approximately 0% to about 90% by dry weight of the tablet composition. Suitable bulk filler agents include, but are not limited to, magnesium carbonate, calcium carbonate, calcium phosphate, calcium sulfate, magnesium silicate, aluminum silicate, ground lime stone, clay, talc, titanium dioxide, microcrystalline cellulose, cellulose polymers such as wood, derivatives thereof, and combinations thereof.

Surfactants

Surfactants may optionally be included in the tablets. Useful surfactants include mono and diglycerides of fatty acids such as, for example, the monoglyceride of C₁₈ fatty acids sold under the Atmos 300 trademark (ICI, Co.), and polyoxyethylene sorbitol esters such as sold under the Polysorbate 80 trademark (ICI, Co.). Combinations of two or more surfactants may also be used to impart the desired properties such as, for example, a polyoxyethylene sorbitan fatty acid ester or an \acute{α}-hydro-\acute{ω}-hydroxypolyoxyethylene-polyoxypropylene-polyoxyethylene block copolymer in combination with a polyoxyethylene alkyl ether or a polyoxyethylene castor oil derivative. Other surfactants include fatty acid esters, pluronic acid, sodium lauryl sulfate, and the like. A surfactant may be added in a desired amount such as amounts ranging from about 0 to about 15 weight %. The total concentration of surfactants in the final tablet depends on, among other things, the properties of the other ingredients, but may be used in amounts ranging from about 0 to about 5 weight %, or more.

Stabilizing Agents

Useful stabilizing agents include guar gum, xanthan gum, locust bean gum, carageenan, and the like, in amounts ranging from about 0 to about 10 weight % or more.

Acids

If desired, one or more acids may be included in the tablet to enhance the flavor sensation of the beverage in which a tablet is dissolved. Exemplary acids include, but are not limited to, citric acid, malic acid, tartaric acid, and fumaric acid, and exemplary amounts range from about 0 to about 25 weight % or more.

Emulsifiers

If desired, one or more emulsifier may also be included in the tablet. An emulsifier may be desired if the tablet includes oils or other hydrophobic components which normally would not readily mix with the aqueous components that may be used in making the tablet. Emulsifiers may improve manufacturability and consistency of the tablet. Exemplary emulsifying agents include casein, triethanolamine stearate, quaternary ammonium compounds, acacia, gelatin, lecithin, bentonite, veegum, and the like, and may be used in amounts ranging from about 0 to about 5 weight %, or more.

Lubricants

One or more lubricants may be useful in the tablet formulation to aid in manufacturability. Exemplary lubricants include magnesium stearate, L-leucine, and polyethylene glycol, and may be used in amounts ranging from about 0 to about 5 weight %, or more.

Effervescence

An optional aspect of the tablet is the inclusion of the property of effervescence. The effervescence can be for visual appeal or entertainment value only, and/or to enhance the quick-dissolve characteristics of the tablet.

Effervescence can be obtained by, for example, mixing alkaline and acidic ingredients, such as sodium bicarbonate and citric acid in the presence of water. Since sodium bicarbonate and citric acid are both dry, they can co-exist in the same tablet, and when the tablet is added to water, gas bubbles will form, and will provide the visual appeal or entertainment value, and/or help the tablet to quickly dissolve.

Examples of alkaline ingredients include, but are not limited to, sodium bicarbonate, potassium citrate, calcium citrate, and sodium citrate.

One example of a method to create an effervescing tablet is to make a two-layer tablet, wherein the top layer contains sodium bicarbonate and the bottom layer contains citric acid. The two layers may be joined in ways known in the art, such as, with a binder.

Another example of a method to create an effervescing tablet is to have a homogeneous tablet containing sodium bicarbonate to which a dry coating of citric acid is applied on the exterior thereof.

Tablet Structure and Shape

Tablets may assume a variety of structures and shapes as described herein or otherwise.

Tablet Structure Examples

In one embodiment, all ingredients of which the tablet is comprised may be mixed prior to forming, making a layer-free, homogeneous tablet.

The tablet may be comprised of a layer-free, homogeneous tablet with a coating sprayed on the outside of the tablet after forming.

Referring to FIG. 1, a tablet of homogenous material is depicted. The tablet in FIG. 1 may be provided with an exterior coating (not shown), such as an acid to effect effervescence, or another coating.

In another embodiment, the tablet may be formed with multiple layers, with or without a coating on the outside, as depicted in FIG. 7, which shows a vertically-layered, two-layer tablet, with each layer differentiated by a different color.

In another embodiment, the tablet may be formed with two layers, oriented either horizontally or vertically, and exhibit a uniform color, with neither layer differentiated so as to make the layers indistinguishable to a consumer, or with a non-uniform color so as to make the layers distinguishable to a consumer.

In another embodiment, the tablet may be provided with a chamber formed therein into which one or more ingredients may be contained, as shown in FIG. 6, which shows a cross-section of a homogeneous, uncoated, spherically-shaped tablet. The tablet cross-section shows the containment chamber 602 enclosed within tablet 601. The containment chamber may house one or more ingredients in powdered, granulated, solid or liquid form, or combinations thereof.

In another embodiment, the tablet may be formed with three layers, organized horizontally or vertically or otherwise, with or without a coating on the outside of the tablet, as depicted in FIG. 8, which depicts a vertically-layered, three-layer tablet, with each layer 801, 802, and 803 differentiated.

In another embodiment, each layer of a multiple-layered tablet may represent different flavors, and may also be represented by different colors.

In another embodiment, each layer of a multiple-layer tablet may contain unique ingredients.

In another embodiment, each layer of a multiple-layer tablet may contain uniform ingredients, but be colored differently to make the tablet more appealing or entertaining for the consumer.

In another embodiment, the multiple-layer tablet may have a uniform color, making the multiple layers not readily susceptible to differentiation by a consumer.

Multiple-layer tablets may be formed for ease of manufacturability, regardless of the ingredient content or color differentiation of the layers.

Tablet Shape Examples

In FIG. 1, a tablet is depicted having a toroidal (doughnut) shape.

In FIG. 2, a cross-sectional view of a toroidal-shaped tablet is provided.

In FIG. 3, a tablet is depicted having a tubular shape.

In FIG. 4, a tablet is depicted having a triangular shape.

In FIG. 5, a tablet is depicted having a spherical shape.

In FIG. 7, a tablet is depicted having a rounded disc shape. The two layer-tablet in FIG. 7 is depicted having a first layer 701 and a second layer 702. The layers may be of the same or of different materials, and may be distinguishable or indistinguishable.

In FIG. 8, a tablet is depicted having an oval or elliptical shape. The three-layer tablet in FIG. 8 is depicted as having a first layer 801, a second layer 802, and a third layer 803. The layers may be of the same or of different materials, and may be distinguishable or indistinguishable.

In FIG. 9, a tablet is depicted having a square shape.

If desired, the tablet may be configured into a shape other than shapes such as a square, rectangle, triangle, round, ovoid, toroid, or other regular shape. For example, the tablet may be provided in an irregular “amoeba-like” shape.

The tablet may also be shaped in the form of an animal, fruit, stars, or other shape for the delight of children.

The tablet may be shaped into a company logo, or a character from a movie, television show, comic strip/book, magazine, book or game for promotional or advertising purposes.

The tablets may be differently shaped to differentiate one type of tablet from another, just as prescription medications and vitamin tablets come in unique shapes to differentiate one from another. Not by way of limitation, this may be accomplished by standard tablet forming techniques, such as compression filling.

Images

In order to increase the attractiveness of the flavor tablets to the consumer, they may include an exterior surface with an embossed, sculpted, molded, sprayed or printed image, figure, logo, text, numerals, graphics, characters, art or words. Edible ink may be used for such optical images.

Such optical representations may be related or unrelated to the flavor that the tablet provides.

Optical representations may be chosen to cause the consumer to experience pleasant thoughts when using the tablet, to attract the consumer's attention in a retail location, for education, for promotion, or for advertising related or unrelated products, or for other reasons. In general the optical images are provided to make the product more entertaining and enjoyable than it would be without the optical images.

The tablet may be printed on one or more sides.

In FIG. 10, a tablet is depicted that includes a tablet 1001 having a graphic image or figure 1002 on it.

Referring to FIG. 11, a view of a tablet is provided that includes tablet 1101 acting as a substrate for lettering or printing 1102. The lettering or printing may be applied to the surface of the tablet or embedded within it such as by embossing, casting, molding, or otherwise.

Coloring

The tablets described herein may provide an aesthetic and pleasing appearance through the use of muted, bright and/or multiple colors, or may have no added colorant.

Colors may be printed onto the tablet using edible ink.

Multiple colors, whether bright or muted, may be used within the same tablet.

Not by way of limitation, multiple colors can be accomplished in a number of ways.

Multiply-colored tablets may be manufactured by including the desired colorants in different batches of tablet ingredients, and use multiple feed streams of different colorants when extruding the tablets.

Multiply-colored tablets may also be manufactured by having a multiple-layer tablet with each layer comprised of a batch of tablet ingredients that includes a different colorant in each batch. Each differently-colored batch of tablet ingredients may be otherwise uniform, or contain different ingredients, for example, but not by way of limitation, different flavors.

Multiply-colored tablets may also be achieved by printing, dipping or dying tablets with edible ink after the tablets have been formed.

The colorant may be integrated in the ingredient formulation at time of manufacture, making the entire tablet homogeneously colored as desired.

Tablet Packaging

In another embodiment, a plurality of tablets is packaged in a dispenser that provides convenient portability of the tablets.

In another embodiment, a plurality of tablets is packaged in a dispenser that provides easy, convenient access to and dispensing of the tablets.

Various types of dispensers are described, by example but not by way of limitation, which provide for neat, straightforward, expedient dispensing of one or more tablets at the consumer's discretion.

Tablet dispensers may feature advertising, labeling, logos, cartoon characters or other representations or other information for the enjoyment, entertainment, or education of a consumer, or to serve other functions.

The tablet dispenser may be reusable or disposable.

Dispensers for quick-dissolve tablets may be provided which have ease and convenience of dispensing, an aesthetically pleasing experience, an entertaining experience, or the ability to promote, advertise, educate, warn and/or instruct.

Ease and convenience of dispensing can be provided in a number of ways. The tablet dispenser may be designed with loose tablets 1201 therein, and which has a snap-open and snap-close lid 1202 in which tablets may be seen when lid is opened. This package may be made of a variety of suitable materials such as, for example, plastic, metal, or a combination thereof.

The tablets may be viewed and removed by the consumer easily and in any quantity desired once the lid has been flipped open. Once the desired number of tablets has been removed, the lid easily snaps shut.

The tablets may be packaged loose inside a dispenser which has an attached flip-top, and an opening accessed via the flip-top through which the tablets can be dispensed, although not readily seen, as shown in FIG. 13.

A dispenser with an attached flip-top and access opening may be square, or rectangular, or circular, or oval, or any other shape, with a square, rectangular, circular, oval flip-top, or any other shape, such as a cartoon head or fanciful shape, or any other shape, or combination thereof.

The tablets may be shaken out singularly or multiply by flipping open the top of the dispenser 1301, and shaking out the desired number of tablets via the opening in the dispenser 1302, then flipping the top of the dispenser closed.

Dispensing the tablets may also be provided by a stack of tablets inside a plastic housing, as shown in FIG. 14, which can have a mechanism (not shown) that pushes the top-most tablet out of the housing to the consumer when the top of the container is drawn back, 1401, so that each time the lid is opened a tablet is offered, 1402.

In this embodiment, a consumer would grasp the tablet and withdraw it from the package shown in FIG. 14, after the top of the dispenser is drawn back and the tablet offered by the mechanism inside the dispenser. Once a tablet has been removed, the consumer releases the top so that a spring biasing the top causes the top to return to the closed position.

The dispenser may also be designed to present the tablets in discrete pieces in a stack inside a plastic housing, as shown in FIG. 15. Depending upon the shape of the tablets therein, the stack may or may not be anchored to a center post (not shown) within the container. The lid 1501, as shown in FIG. 15, is attached to the dispenser.

In another embodiment, the lid of a dispenser may be completely removable from the dispenser, and may feature either a snap-close or screw threads to permit the lid to be removed and replaced by the user.

To dispense tablets from a dispenser which provides tablets in a stack, the lid is removed, either by flipping it back if it is integral to the package, or removing it altogether by pulling or unscrewing the top if it is separate from the tablet containment housing. The dispenser would then be inverted by a consumer and the desired number of tablets allowed to emerge from the housing. The lid would then be replaced either by flipping, snapping, or twisting it into place.

The tablets may also be packaged in roll form, wrapped in, for example, foil and/or paper, and without a plastic housing, as shown in FIG. 16.

Tablets wrapped in a roll form can be easily accessed and removed by tearing back the paper or foil packaging 1601 to expose the tablets 1602, and removing the desired quantity of tablets. The foil or paper may then be re-wrapped around the remaining tablets.

The tablets may also be packaged in a blister pack, as shown in FIG. 18, in which individual tablets 1801 are enclosed within individual plastic chambers 1802, the reverse side of which (not shown) is sealed with foil or similar type material.

Tablets in a blister pack are normally accessed individually. To utilize multiple tablets at one time, multiple blister pack chambers would be opened sequentially.

Additionally, the shape of the packaging may entertain, delight, educate, warn, instruct, promote or advertise. For example, the packaging can be made into the form of a character from a movie, television show, book, magazine, cartoon, game, or logo.

A further aspect is a dispenser which is utilitarian in addition to its containing and dispensing of the tablets. For example, the dispenser may be part of a keychain or a pants belt or a water bottle holder, or be designed to fit within a compartment thereof.

An exemplary utilitarian dispenser is shown in FIG. 17, showing a dispenser which contains loose tablets (not visible), and a flip-top which is attached to the dispenser 1701, which when flipped back provides access to an opening from which tablets can be shaken out 1702, with an integrated belt clip 1703.

The packaging, whether paper, foil, plastic metal or otherwise, will provide a sufficient moisture barrier such that the tablets do not absorb sufficient humidity to cause them to degrade or clump together.

A method for providing the tablets in a convenient dispenser is also disclosed. At the time of manufacture, after the tablets have been formed, tablets are placed into the designated packaging. The packaging is then sealed, either with shrink-wrap, tape, or with secondary packaging, to ensure tamper resistance.

Methods for Making Tablets

A number of different methods for manufacturing quick-dissolve, water-soluble tablets may be employed. Examples include, but not by limitation, high- and low-compression forming, non-compression filling, extrusion, and molding.

In one embodiment, the manufacturing process will utilize lower-compression molding in order to optimize the friability of the tablets, allowing them to dissolve easily when placed into an aqueous medium while maintaining their integrity during the packaging and distribution processes.

The tablets may be made out of a granular or powdered base material in which liquid is never present. Alternatively, the tablets may be made out of a base material from which liquid is evaporated.

In another embodiment, a slurry may be used in forming the tablets with the liquid substantially removed from the tablets after forming.

Other techniques may also be employed such as, for example, microencapsulation, spray drying, spray chilling, freeze drying, and coacervation. Nanotechnologies may also be used as desired by the skilled artisan.

Exemplary Method for Manufacturing Quick-Dissolve Tablets

All ingredients are placed into the bowl of a dry blender such as, for example, a Ross ribbon blender, a vertical cone screw blender, a horizontal blender, or other type of dry blender, and blended until fully homogenized, typically 30 seconds to three minutes.

The mixture is transferred to the hopper of a tableting machine, for example, a Stokes tableting machine. Low-compression is used to form tablets into the desired shape per the tooling that is utilized.

Finished tablets may then be conveyed to spraying or coating equipment, where additional ingredient(s), such as colorants, designs, acids or alkalines to aid effervescence, flavors, or other ingredients are applied as desired. If necessary, sprayed or coated tablets may be conveyed to a drying tunnel or other mechanism to dry.

After tableting and optional coating are complete, tablets are conveyed to a packaging line where they are packaged into appropriate containers for distribution. Tablets may be packaged individually, in discrete quantities, or in bulk.

Mass or Interior Volume

The tablets disclosed herein typically are sized for placement in a beverage container, such as a bottle, and shaped to facilitate rapid dissolution or disintegration. Tablets disclosed herein may be of any desired thickness, length, width, and shape provided they are capable of being placed in a beverage container and quickly dissolved therein.

### TABLET EXAMPLES

The following examples illustrate a number of tablet embodiments. These examples are illustrative only and should not be considered limiting. An example base tablet formulation is used to which other ingredients are added that make each example tablet unique. The examples will refer to the base tablet formulations, in which the numbers represent parts by weight.

TABLE 2

| | |
|---|---|
| Weight Percent | Ingredient |

Base Tablet Formulation A

| | |
|---|---|
| 59.65 | Cane sugar |
| 17.89 | Malic acid |
| 11.93 | Natural flavor |
| 5.96 | Polyvinylpyrrolidone |
| 1.79 | Potassium citrate |
| 1.79 | Sucralose |
| 0.33 | L-leucine |
| 0.33 | Polyethylene glycol |
| 0.33 | Silica |
| 100.00 | |

Base Tablet Formulation B

| | |
|---|---|
| 71.35 | Natural Flavor WONF |
| 0.35 | Sucralose |
| 14.45 | Citric Acid |
| 4.30 | Fumaric Acid |
| 9.55 | Magnesium Stearate |
| 100.00 | |

### Example 1

To the basic formulation A or B, an artificial flavor may be added or substituted. Additionally, a natural or FD&C artificial color may also be added to provide a desired shade to complement the particular flavor added to the tablet mixture. The mixture is thoroughly blended and made into tablet slurry. The slurry is then pressed into the desired mold shape, and dried. The tablets are then packed as stacks into flip-top dispensers. The consumer opens the top, shakes out one or more tablets, closes the lid of the dispenser, and deposits the one or more dispensed tablets into a container of water or other beverage. The bottle of water or other beverage may be shaken by the consumer. The tablet dissolves rapidly, and flavors and sweetens the beverage, providing the consumer with flavor satisfaction.

### Example 2

Other flavors which may be used as the flavor component of the tablets are, for example, lemon, lime, orange, grapefruit, melogold, pummelo, calamondin, mandarin orange, clementine, tangerine, tangelo, uniq fruit, apple, peach, nectarine, plum, pluot, prune, jujube, pear, Asian pear, prickly pear, apricot, wampee, tamarind, lychee, grape, physalis, pitaya, sapodillas, pomegranate, persimmon, Sharon fruit, soursop, guanabana, quince, logan, loquat, jaboticaba, jackfruit, strawberry, kiwi, strawberry-kiwi, currant, raspberry, blueberry, cranberry, boysenberry, huckleberry, gooseberry, brambleberry, keriberry, mixed berry, cantaloupe, honeydew, watermelon, kavamelon, muskmelon, pepino melon, calabaza, pumpkin, tamarillo, white sapote, cherimoya, cherry, passion fruit, mango, papaya, guava, mamey sapote, kiwano, kumquat, lemonquat, limequat, atemoya, pineapple, monstera deliciosa, coconut, vanilla, cinnamon and other spices, capsicum and other peppers, cucumber and other vegetables, rose, lavender, lemongrass and other herbs, almond and other nuts, peppermint, spearmint and other mints, chocolate, butterscotch and other candy flavors.

While tablets have been described and illustrated in conjunction with a number of specific ingredients, materials and configurations herein, the skilled artisan will appreciate that variations and modifications may be made without departing from the principles herein illustrated, described, and claimed. The present invention, as defined by the appended claims, may be embodied in other specific forms without departing from its spirit or essential characteristics. The configurations of tablets described herein are to be considered in all respects as only illustrative, and not restrictive. All changes which come within the meaning and range of equivalency of the claims are to be embraced within their full scope.

We claim:

1. A quick-dissolve flavor tablet for flavoring a beverage in a container comprising a flavor component and a quick-dissolve carrier component, wherein the tablet is capable of dissolving upon placement in the beverage container with minimal residue.

2. The tablet of claim 1, wherein the flavor component comprises at least two flavors.

3. The tablet of claim 1 further comprising a sweetener.

4. The tablet of claim 1 further comprising a colorant.

5. The tablet of claim 1, wherein the tablet dissolves substantially completely upon placement in the beverage container in a time period selected from the group consisting of less than about 1 minute, less than about 45 seconds, less than about 30 seconds, less than about 15 seconds, less than about 10 seconds, less than about 5 seconds, less than about 3 seconds, and less than about 1 second.

6. The tablet of claim 1 further comprising an optical representation disposed thereon.

7. The tablet of claim 6, wherein the optical representation is selected from the group consisting of text, numbers, words, figures, logos, graphics, characters, art, advertising, educational materials, and combinations thereof.

8. The tablet of claim 6, wherein the optical representation formed on the tablet by a method selected from the group consisting of embossing, debossing, printing, and combinations thereof.

9. The tablet of claim 1, wherein the tablet is provided in a shape selected from the group consisting of round, spherical, toroidal, oblong, S-shaped, Z-shaped, triangular, square, rectangular, quadrilateral, pentagonal, hexagonal, heptagonal, octagonal, tubular, helical, irregular, and combinations thereof.

10. The tablet of claim 1, wherein the tablet is provided in a shape selected from the group consisting of an animal, a logo, a character, and combinations thereof.

11. A dispenser for dispensing the tablet of claim 1, comprising a dispenser body having a cavity for holding a plurality of the tablets of claim 1 and an opening through which one or more tablets are dispensed.

12. A water-soluble, quick-dissolve flavor tablet for flavoring a beverage in a container comprising a flavor component having at least one flavor and one or more sweeteners, and optionally, one or more colorants, disposed in a quick-dissolve carrier component, wherein the tablet is capable of dissolving upon placement in the beverage container with minimal residue.

13. The tablet of claim 12, wherein the ingredients of the flavor component are selected from the group consisting of flavorings, sweeteners and acids, and wherein the tablet optionally includes one or more ingredients selected from the group consisting of gelatin components, bulking agents, carbohydrates, formers, plasticizers, stabilizers, emulsifiers, lubricants, fillers, thickeners, binders, starches, gums, edible polymers, cellulose ethers, hydrocolloid flours, seaweed extracts, land plant extracts, derivatives thereof, and combinations thereof.

14. A method for flavoring a beverage in a container comprising the step of placing the tablet of claim 1 into the container.

15. A method for customizing the strength of the flavor of a beverage in a container comprising the step of placing a desired number of the tablets of claim 1 into the container.

16. A method for customizing the flavor of a beverage in a container comprising the step of placing at least two of the tablets of claim 1 having different flavor components into the container.

17. A method for making the tablet of claim 12, comprising the steps of: (a) providing at least one flavor component and a quick-dissolve carrier component, (b) mixing the components, and (c) forming the tablet from the mixture of the components.

18. The tablet of claim 12 further comprising an effervescing component.

19. The tablet of claim 12 further comprising one or more ingredients selected from the group consisting of vitamins, minerals, stimulants, herbs, plant-based supplements, probiotics, prebiotics, nutraceuticals, and combinations thereof.

20. The tablet of claim 12 further comprising one or more medicaments.
